(19) United States
(12) Patent Application Publication
(10) Pub. No.: US 2026/0129473 A1
(43) Pub. Date: May 7, 2026

(54) INTERFERENCE PREDICTION FOR AIML BM

(71) Applicant: InterDigital Patent Holdings, Inc., Wilmington, DE (US)

(72) Inventors: Young Woo Kwak, Woodbury, NY (US); Yugeswar Deenoo Narayanan Thangaraj, Chalfont, PA (US); Haseeb Ur Rehman, Winnipeg (CA)

(73) Assignee: InterDigital Patent Holdings, Inc., Wilmington, DE (US)

(21) Appl. No.: 18/936,384

(22) Filed: Nov. 4, 2024

(51) Int. Cl. H04W 24/02; H04L 5/00; H04W 24/08

(52) U.S. Cl. CPC H04W 24/02; H04L 5/0048; H04W 24/08

(57) ABSTRACT

A wireless transmit/receive unit (WTRU) may be configured with configuration information for interference prediction. The configuration information may indicate one or more resources for interference measurement, and one or more resources for interference prediction. The WTRU may determine, based on the configuration information, to perform interference measurements for one or more of the resources indicated as being for interference measurement. The WTRU may determine interference predictions based at least in part on the interference measurements. The interference predictions may be made using an artificial intelligence or machine learning (AIML) model. The WTRU may create and send a report indicating a result of the interference predictions.

### BACKGROUND

Artificial intelligence may be broadly defined as behaviors exhibited by machines that mimic cognitive functions to sense, reason, adapt and/or act.

Machine learning may refer to type of algorithms that solve a problem based on learning through experience (e.g., data), without explicitly being programmed (e.g., by configuring a set of rules). Machine learning can be considered as a subset of AI. Different machine learning paradigms may be envisioned based on the nature of data or feedback available to the learning algorithm. For example, a supervised learning approach may involve learning a function that maps input to an output based on labeled training example. In such cases, each training example may be a pair consisting of input and the corresponding output. Unsupervised learning approaches may involve detecting patterns in the data with no pre-existing labels. For example, a reinforcement learning approach may involve performing a sequence of actions in an environment to maximize a cumulative reward. In some solutions, machine learning algorithms may use a combination or interpolation of the above-mentioned approaches. For example, semi-supervised learning approach may use a combination of a small amount of labeled data with a large amount of unlabeled data during training. In this regard, semi-supervised learning falls between unsupervised learning (e.g., with no labeled training data) and supervised learning (e.g. with only labeled training data).

Deep learning may refer to a class of machine learning algorithms that employ artificial neural networks (e.g., Deep Neural Networks (DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers. Each layer may include linear transformation and/or a given non-linear activation function. The DNNs can be trained using the training data (e.g., via a back-propagation algorithm). DNNs have shown state-of-the-art performance in variety of domains, such as speech, vision, natural language etc., and for various machine learning settings such as supervised, un-supervised, and semi-supervised. The term AIML based methods/processing may refer to the realization of behaviors and/or conformance to requirements by learning based on data, without explicit configuration of sequence of steps of actions. Such methods may enable learning complex behaviors which might be difficult to specify and/or implement when using legacy methods.

### SUMMARY

A WTRU may predict interference for different interference hypotheses based on measurements of resources for a subset of hypotheses according to a measurement beam.

A WTRU can dynamically switch its reporting mode based on beam prediction and/or interference prediction. The WTRU can be configured with multiple reference signal (RS) resources for interference measurement (e.g., Set B for interference measurement). Each RS resource for signal measurement may be associated with a quantity, M, of RS resources for interference measurement.

A WTRU may report one or more interference hypotheses (e.g., the best and/or worst interference hypotheses by indicating IMRs with lowest/highest interferences). Based on the determined qualities, the WTRU may indicate one or more resources in Set B and one or more resources of the multiple RS resources for interference prediction (e.g., Set A for interference prediction). For example, the WTRU may indicate the Top K resources and Top L resources for each of the Top K resources.

A WTRU may perform dynamic switching of its reporting mode. The WTRU may evaluate the prediction accuracy of signal prediction and interference prediction and determines a reporting mode between signal prediction reporting and interference prediction reporting.

A WTRU may receive configuration information for interference prediction. The configuration information may indicate a set of RS resources for interference measurement and a set of RS resources for interference prediction. The RSs indicated by the RS resources may, for example, be channel state information RSs (CSI-RSs), channel state information RSs for interference (CSI-IMs), and/or non-zero power channel state information RSs (NZP CSI-RSs) for interference. The WTRU may determine interference measurements for one or more (e.g., all) of the RS resources in the set of RS resources for interference measurement. The WTRU may determine interference predictions for one or more (e.g., all) of the RS resources in the set of RS resources for interference prediction. The WTRU may send a report indicating a result of the interference prediction.

The interference predictions may be in decibels or another unit. The interference predictions may be generated using an AIML model. The interference measurements may be used as input to the AIML model. The interference measurements may include reference signal received power (RSRP), received signal strength indicator (RSSI), and/or signal to noise and interference ratio (SINR) measurements.

The interference prediction report may indicate one or more (e.g., all) of the RS resources, interference measurements, and/or interference predictions. In examples, the interference prediction report may indicate the top K interference measurements/predictions. In examples, the interference prediction report may indicate any measurements/predictions that meet a certain threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a sequence diagram illustrating an example of an interference prediction procedure.

### DETAILED DESCRIPTION

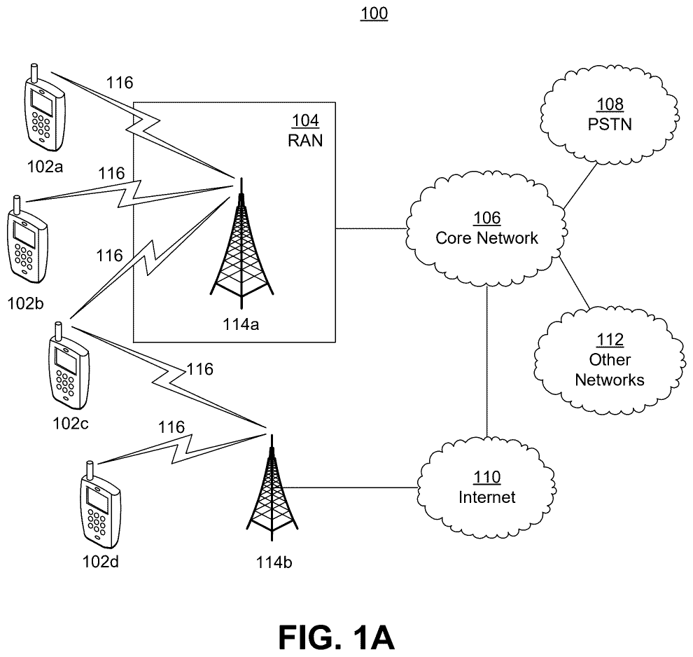

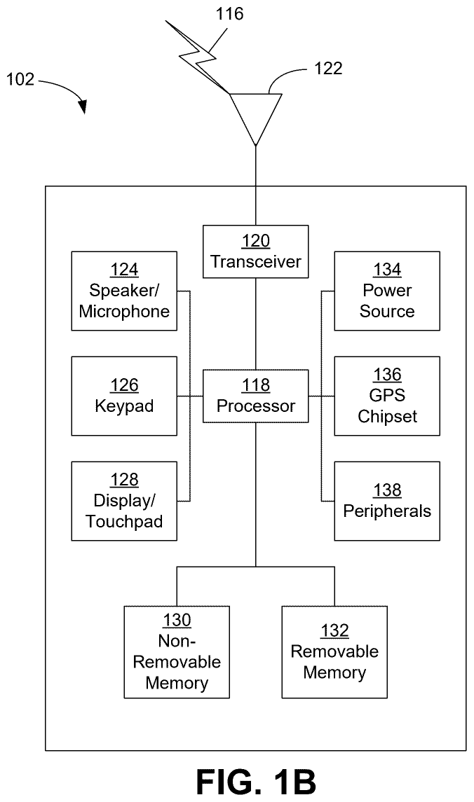

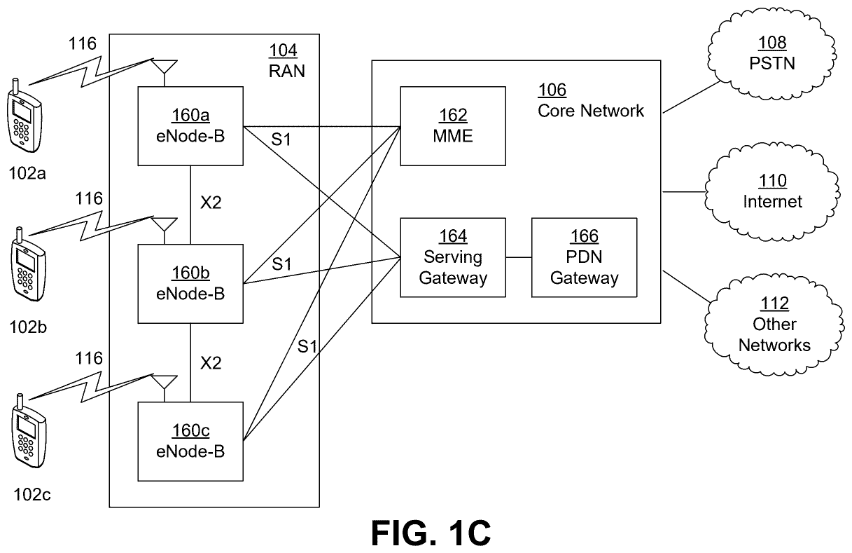

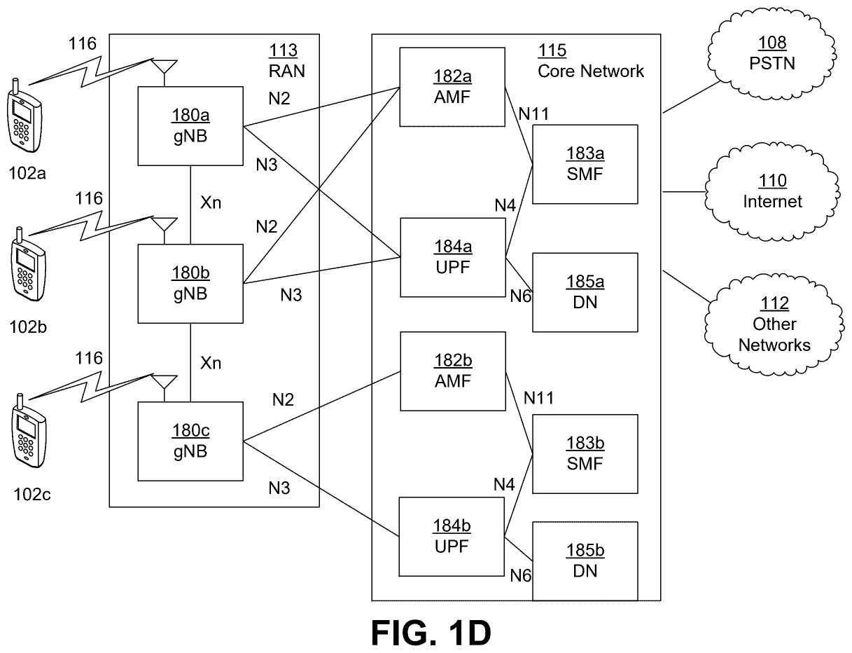

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (e.g., such as a channel state information (CSI)-RS or a synchronization signal (SS) block (SSB). The WTRU transmission may be referred to as the “target”, and the received RS or SS block may be referred to as the “reference” or “source”. In such a case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as the “target” and the “reference” (e.g., or “source”), respectively. In such cases, the WTRU may be said to transmit the first (e.g., target) physical channel or signal according to a spatial relation with a reference to the second (e.g., reference or source) physical channel or signal.

A spatial relation may be implicit, configured by radio resource control (RRC) or signaled by a medium access control (MAC) control element (CE) or downlink control information (DCI). For example, a WTRU may implicitly transmit a physical uplink shared channel (PUSCH) and a demodulation reference signal (DM-RS) of PUSCH according to the same spatial domain filter as a sounding reference signal (SRS) indicated by an SRS resource indicator (SRI) indicated in DCI or configured by RRC. In examples, a spatial relation may be configured by RRC for an SRI or signaled by MAC CE for a physical uplink control channel (PUCCH). Such spatial relation may also be referred to as a “beam indication”.

The WTRU may receive a first (e.g., target) downlink channel or signal according to the same spatial domain filter or spatial reception parameter as a second (e.g., reference or source) downlink channel or signal. For example, such association may exist between a physical channel such as the physical downlink control channel (PDCCH) or physical downlink shared channel (PDSCH) and its respective DM-RS. In examples, when the first and second signals are reference signals, such an association may exist when the WTRU is configured with a quasi-colocation (QCL) assumption type D between corresponding antenna ports. Such an association may be configured as a transmission configuration indicator (TCI) state. An index to a set of TCI states configured by RRC and/or signaled by MAC CE may indicate to the WTRU that an association exists between a CSI-RS or SS block and a DM-RS. Such an indication may also be referred to as a “beam indication”.

Herein, a transmission and reception point (TRP) may be interchangeably used with one or more of transmission point (TP), reception point (RP), radio remote head (RRH), distributed antenna (DA), base station (BS), a sector (e.g., of a BS), and/or a cell (e.g., a geographical cell area served by a BS). Herein, multi-TRP may be interchangeably used with one or more of MTRP, M-TRP, and multiple TRPs.

CSI components are discussed herein. A WTRU may report a subset of channel state information (CSI) components. CSI components may correspond to one or more of the following: a CSI-RS resource indicator (CRI), a SSB resource indicator (SSBRI), an indication of a panel used for reception at the WTRU (e.g., such as a panel identity or group identity), measurements such as layer one (L1) reference signal received power (L1-RSRP), L1-signal to noise ratio (SINR) taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

Channel and/or Interference Measurements are discussed herein. A WTRU may receive a synchronization signal/physical broadcast channel (SS/PBCH) block. The SS/PBCH block (SSB) may include a primary synchronization signal (PSS), a secondary synchronization signal (SSS), and/or a physical broadcast channel (PBCH). The WTRU may monitor, receive, and/or attempt to decode an SSB during initial access, initial synchronization, radio link monitoring (RLM), cell search, cell switching, and so forth.

A WTRU may measure and report the channel state information (CSI) (e.g., from the CSI-RS). The CSI for each connection mode may include or be configured with one or more of following: a CSI Report Configuration, a CSI-RS resource set, and/or one or more non-zero power (NZP) CSI-RS Resources.

The CSI Report Configuration may include one or more of the following. The CSI Report Configuration may include CSI report quantity, e.g., Channel Quality Indicator (CQI), Rank Indicator (RI), Precoding Matrix Indicator (PMI), CSI-RS Resource Indicator (CRI), Layer Indicator (LI), etc. The CSI Report Configuration may include a CSI report type, for example, aperiodic, semi persistent, periodic. The CSI Report Configuration may include a CSI report codebook configuration, for example, Type I, Type II, Type II port selection, etc. The CSI Report Configuration may include a CSI report frequency.

The CSI-RS Resource Set may include one or more of the following CSI Resource settings. The CSI-RS Resource Set may include an NZP-CSI-RS Resource for channel measurement. The CSI-RS Resource Set may include an NZP-CSI-RS Resource for interference measurement. The CSI-RS Resource Set may include a CSI-IM Resource for interference measurement.

The NZP CSI-RS Resources may include one or more of the following. The NZP CSI-RS Resources may include an NZP CSI-RS Resource ID. The NZP CSI-RS Resources may include a periodicity and/or an offset. The NZP CSI-RS Resources may include QCL Info and/or a TCI-state. The NZP CSI-RS Resources may include a resource mapping, which may, in examples, indicate a number of ports, a density, code division multiplexing (CDM) type, etc.

A WTRU may indicate, determine, or be configured with one or more reference signals. The WTRU may monitor, receive, and/or measure one or more parameters based on the respective reference signals. One or more of the following may apply. The following parameters are non-limiting examples of the parameters that may be included in reference signal(s) measurements. One or more of these parameters may be included. Other parameters may be included.

Reference signal measurements may include SS-RSRP. SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be applied. In case SS-RSRP is used for L1-RSRP, the measurement may be accomplished based on CSI reference signals in addition to the synchronization signals.

Reference signal measurements may include CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

Reference signal measurements may include SS-SINR. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

Reference signal measurements may include CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Reference signal measurements may include RSSI. Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).

Reference signal measurements may include CLI-RSSI. Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth).

Reference signal measurements may include SRS-RSRP. Sounding reference signals RSRP (SRS-RSRP) may be measured based on the linear average over the power contribution of the resource elements (RE) that carry the respective SRS.

Beam and CSI Report Configuration are considered herein. A CSI report configuration (e.g., CSI-ReportConfigs) may be associated with a single BWP (e.g., indicated by BWP-Id). One or more of the following parameters may be configured.

A CSI report configuration may include CSI-RS resources and/or CSI-RS resource sets for channel and interference measurement. A CSI report configuration may include a CSI-RS report configuration type, such as periodic, semi-persistent, and aperiodic. A CSI report configuration may include a CSI-RS transmission periodicity for periodic and semi-persistent CSI reports.

A CSI report configuration may include a CSI-RS transmission slot offset for periodic, semi-persistent and aperiodic CSI reports. A CSI report configuration may include a CSI-RS transmission slot offset list for semi-persistent and aperiodic CSI reports. A CSI report configuration may include time restrictions for channel and interference measurements.

A CSI report configuration may include report frequency band configuration (e.g., wideband and/or subband CQI, PMI, and so forth). A CSI report configuration may include thresholds and modes of calculations for the reporting quantities (CQI, RSRP, SINR, LI, RI, etc.). A CSI report configuration may include a codebook configuration. A CSI report configuration may include an indication for group based beam reporting.

A CSI report configuration may include a CQI table. A CSI report configuration may include a Subband size. A CSI report configuration may include a non-PMI port indication. A CSI report configuration may include a Port Index.

The above examples are not limiting. In examples, a CSI report configuration may include parameters not expressly mentioned herein.

CSI-RS Resource Configuration is considered herein. A CSI-RS Resource Set (e.g., NZP-CSI-RS-ResourceSet) may include one or more CSI-RS resources (e.g., NZP-CSI-RS-Resource and CSI-ResourceConfig). A WTRU may be configured with one or more of the following in a CSI-RS Resource Configuration.

A CSI-RS Resource configuration may include a CSI-RS periodicity and/or slot offset for periodic and semi-persistent CSI-RS Resources. A CSI-RS Resource configuration may include a CSI-RS resource mapping to define the number of CSI-RS ports, density, CDM-type, OFDM symbol, and/or subcarrier occupancy. A CSI-RS Resource configuration may include the bandwidth part to which the configured CSI-RS is allocated. A CSI-RS Resource configuration may include the reference to the TCI-State including the QCL source RS(s) and the corresponding QCL type(s).

RS resource set Configuration is considered herein. One or more of following configurations may be used for a RS resource set. A WTRU may be configured with one or more RS resource sets. The RS resource set configuration may include one or more of following: a RS resource set ID; one or more RS resources for the RS resource set; a Repetition (e.g., on or off); an Aperiodic triggering offset (e.g., one of 0-6 slots); and/or TRS info (e.g., true or not).

RS resource Configuration is considered herein. One or more of following configurations may be used for RS resource. A WTRU may be configured with one or more RS resources. The RS resource configuration may include one or more of following.

The RS resource configuration may include a RS resource ID. The RS resource configuration may include a Resource mapping (e.g., REs in a PRB). The RS resource configuration may include a Power control offset (e.g., one value of −8, . . . , 15). The RS resource configuration may include a Power control offset with SS (e.g., −3 dB, 0 dB, 3 dB, 6 Db). The RS resource configuration may include a Scrambling ID. The RS resource configuration may include a Periodicity and offset. The RS resource configuration may include QCL information (e.g., based on a TCI state).

[Properties of a grant or an assignment are now considered. Herein, a property of a grant or assignment may include one or more of the following.

A property of a grant or assignment may comprise a frequency allocation. A property of a grant or assignment may comprise an aspect of time allocation, such as a duration.

A property of a grant or assignment may comprise a priority. A property of a grant or assignment may comprise a modulation and coding scheme. A property of a grant or assignment may comprise a transport block size.

A property of a grant or assignment may comprise a number of spatial layers. A property of a grant or assignment may comprise a number of transports blocks. A property of a grant or assignment may comprise a TCI state, CRI or SRI. A property of a grant or assignment may comprise a number of repetitions.

A property of a grant or assignment may comprise an indication of whether the repetition scheme is Type A or Type B. A property of a grant or assignment may comprise an indication of whether the grant is a configured grant type 1, type 2 or a dynamic grant. A property of a grant or assignment may comprise an indication of whether the assignment is a dynamic assignment or a semi-persistent scheduling (configured) assignment.

A property of a grant or assignment may comprise a configured grant index or a semi-persistent assignment index. A property of a grant or assignment may comprise a periodicity of a configured grant or assignment. A property of a grant or assignment may comprise a channel access priority class (CAPC). A property of a grant or assignment may comprise any parameter provided in a DCI, by MAC, by LPP or by RRC for the scheduling the grant or assignment.

The above examples are merely illustrative and not meant to be limiting. A property of a grant or assignment may comprise additional parameters not expressly mentioned herein.

Herein, an indication by DCI may include one or more of the following. An indication by DCI may include an explicit indication by a DCI field or by RNTI used to mask CRC of the PDCCH. An indication by DCI may include an implicit indication by a property such as DCI format, DCI size, Coreset or search space, Aggregation Level, first resource element of the received DCI (e.g., index of first Control Channel Element). The mapping between the property and the value may be signaled by RRC or MAC.

Herein, RS may be interchangeably used with one or more of RS resource, RS resource set, RS port and/or RS port group. Herein, RS may be interchangeably used with one or more of SSB, CSI-RS, SRS, DM-RS, TRS, PRS, and/or PTRS.

Herein, the term, “reference signal” may be interchangeably used with one or more of following: Sounding reference signal (SRS), Channel state information-reference signal (CSI-RS), Demodulation reference signal (DM-RS), Phase tracking reference signal (PT-RS), Synchronization signal block (SSB), etc.

Herein, the term, “channel” may be interchangeably used with one or more of following: PDCCH, PDSCH, Physical uplink control channel (PUCCH), Physical uplink shared channel (PUSCH), Physical random access channel (PRACH), Etc.

A key performance indicator (KPI) may refer to, but is not limited to, one or more of the following. A KPI may refer to an indication of signal quality (e.g., L1-RSRP, SINR, CQI, RSSI, RSRQ). A KPI may refer to a prediction performance. In examples, a prediction performance may indicate a probability or percentage that the Top K best beams based on measurements are the Top K predicted beams. Herein, “best” beams may refer to the RS resources with the highest measured/predicted quality (e.g., RSRP). The “worst” beams may refer to the RS resources with lowest measured/predicted quality (e.g., RSRP). A KPI may refer to an indication of link quality (e.g., throughput, block error rate (BLER)). A KPI may refer to data distribution (e.g., mean and/or variance of measured and/or predicted beam measurements). A KPI may refer to RSRP (e.g., L1-RSRP) difference (e.g., the difference between measured and predicted RSRP of a beam).

A KPI may be based on measurements, predictions, and/or a combination of measurements and predictions.

Herein, a signal, channel, and message (e.g., as in DL or UL signal, channel, and message) may be used interchangeably.

Herein, a RS resource set may be interchangeably used with a RS resource and a beam group.

Herein, beam reporting may be interchangeably used with CSI measurement, CSI reporting and beam measurement.

Herein, the proposed solutions for beam resources prediction may be used for beam resources belonging to a single or multiple cells as well as single or multiple TRPs.

Herein, CSI reporting may be interchangeably used with CSI measurement, beam reporting and beam measurement.

Herein, a RS resource set may be interchangeably used with a beam group.

Herein, a Set B may be interchangeably used with a set of RS resource sets, beams, beam-pairs, beam RS resources, RS resources and a beam pattern.

Herein, Set B may be interchangeably used with measurement RS resources, measurement RS resource set, measurement beam resources, measurement beam resource set, measurement beam pattern, measurement TCI states, measurement TCI state group etc.

Herein, a Set A may be interchangeably used with a set of RS resource sets, beams, beam-pairs, beam RS resources, RS resources, and/or a beam pattern.

Herein beam prediction accuracy may be interchangeably used with prediction accuracy.

WTRU capability and related aspects are now considered.

There may be some WTRU capability communication between the WTRU and the network about the WTRU's AIML capability. In examples, the WTRU can indicate to the network the supported AIML models/functions, confidence level of predictions, time horizon of predictions (e.g., how far along in the future are the prediction being made), etc.

The WTRU may support one or more AIML models for a certain functionality. In examples, a WTRU may support a plurality of AIML models, wherein one or more models may have different prediction time horizons, prediction confidence levels, processing requirements, etc. One or more of the models may be trained under/for operation in different frequencies/cells/location/times of day, etc.

A given AIML model can operate in different modes. In examples, different modes for a given AIML model may have different levels of prediction confidence levels depending on conditions such as the prediction time horizon, the location, the frequencies involved, the WTRU mobility pattern/speed, and/or etc.

The AIML models can be available at the WTRU already trained, and/or the WTRU may be provided with an untrained AIML model and perform the training by itself.

In some cases, the AIML model is available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, for different WTRU speeds, etc.).

In some cases, the AIML model is available at the WTRU, but the AIML model is not trained at all or is only trained for certain WTRU/network conditions. In such cases, the WTRU may be configured to train the model (e.g. for the conditions that it is not trained for).

In some cases, the WTRU may require some configurations and/or inputs that it needs for performing the inference using an AIML model. For example, for beam prediction, the WTRU may need to be configured with a certain number of beams to measure to measure other beams (e.g., set A/B configuration referred to herein). In some cases, the WTRU may communicate the required configuration/input as part of the capability information. In some cases, the required configuration/input may be communicated to the network after capability request (e.g., based on explicit network request, if the WTRU gets configured to do AIML based BM operations and it has determined that it is lacking the required configuration/input, etc.).

A given AIML functionality may be associated with a set of KPIs (Key Performance Indicators) and/or metrics. In examples, this could be prediction accuracy, an average or mean square difference between measured and predicted values, etc. For example, for the beam prediction, these could be the beam prediction accuracy and/or confidence level, the L1 RSRP difference between the measured and predicted beam signal levels, etc. A WTRU may have one or more AIML models for a given functionality, and each may have performance levels that meet different KPI thresholds (e.g., WTRU may have 2 models, where one has an accuracy level of 90% and another one with an accuracy level of 95%, etc.). The WTRU may inform the network (e.g., about its AIML models and the associated KPI thresholds) during its capability reporting or after the capability reporting.

Consistency between training and inference is now considered. A given AIML model may be trained under certain WTRU and network side additional conditions. For example, a WTRU side condition could be the speed of the UE. On the other hand, network side additional conditions could be something that may be related to network configurations and/or settings that the WTRU may not be aware of, but which may impact the performance of the model. For example, an AIML beam management model may perform differently if it is trained when the network was using a certain antenna pattern, beam pattern, power levels, and so on. Also, there could be aspects related to network load, that may have impact on the model performance.

In examples, the WTRU may not need to know one or more (e.g., all) of the details of the network side additional conditions. The network may also not want to expose some of these conditions in implementation. The network could hide these details by signaling to the WTRU one or more associated ID(s). For example, when data is being collected for training a model, tagging may be performed indicating under which network side additional conditions the model is being trained. When a WTRU is being configured to perform an AIML operation, it may be configured to check the consistency between the conditions under which the AIML model is trained on and current conditions (e.g., current WTRU conditions, current associated ID(s) signaled by the network indicating current network conditions/settings, etc.).

Herein, the full or partial validity and/or applicability of an associated ID may refer to whether the WTRU has an AIML model/functionality that is valid/applicable for the concerned associated ID. For example, the network may signal the same associated ID(s) to multiple UE, and a first WTRU may determine it to be fully applicable, a second WTRU may determine it to be partially applicable and a third WTRU may determine it to be not applicable at all.

Life Cycle Management (LCM) is considered herein. The term Life cycle management (LCM) may be used to describe the overall management aspects of AIML models, including but not limited to the following.

Aspects of LCM include model training, Functionality/model identification, model delivery/transfer, and/or model inference operation.

Aspects of LCM include functionality/model selection, activation, deactivation, switching, and fallback operations. In examples, this may include decisions by the network (e.g., either network initiated or WTRU-initiated and requested to the network), decisions by the WTRU (e.g., event-triggered as configured by the network, WTRU's decision being reported to the network, and/or WTRU-autonomous either with WTRU's decision being reported to the network or without it).

Aspects of LCM include functionality/model monitoring, model updates, WTRU capability (e.g., signaling and reporting), and/or data collection (for model training, for monitoring, for inference, etc.).

LCM can be functionality-based LCM or model-ID based LCM. In functionality-based LCM, network may indicate activation, deactivation, fallback, and/or switching of AIML functionality via 3GPP signaling (e.g., RRC, MAC-CE, DCI). in some cases, models may not be identified at the Network, and the WTRU may perform model-level LCM. A WTRU may have one AIML model for the functionality, or the WTRU may have multiple AIML models for the functionality.

In model-ID-based LCM, models may be identified at the Network, and Network/WTRU may activate, deactivate, select, and/or switch individual AIML models via model ID.

In functionality based LCM, the WTRU may choose the AIML model to use for a certain functionality (e.g., network decides for which functionalities the WTRU can use AIML based operation, and the WTRU chooses the AIML model to use).

In the model-ID based LCM, the network may explicitly control which particular model is used for a given AIML functionality. For example, the WTRU may provide details of AIML models and their capabilities, and network may determine which model to activate for a particular functionality.

The solution descriptions below are applicable to both model-ID based and functionality-based LCM. That is, the solutions are related to how the WTRU determines whether it has a model that is applicable for the indicated associated ID(s). For example, (e.g., in the case of functionality-based LCM) the WTRU may be configured/requested to determine if a given functionality is valid/applicable. The WTRU may make the determination among all the models it has for a given functionality. The WTRU may consider the functionality applicable if at least one of the models is applicable. In an example, in the case of model-ID based LCM, the WTRU may be configured/requested by the network to determine whether a particular model is applicable or not.

Activation of an associated ID is discussed herein. Herein, the activation of an associated ID involves the network configuring the WTRU with an associated ID to use/consider. The network may, as part of activation of an associated ID, further indicate to the WTRU to determine if the WTRU has an AIML model or functionality that is applicable for that associated ID (e.g., and sub-associated IDs).

Herein, an associated ID may be applicable if the WTRU has an AIML functionality or model that is applicable for the concerned associated ID (e.g., and related sub-associated IDs).

In the case of functionality based LCM, the WTRU may consider the associated ID applicable (e.g. or partially applicable) if there is at least one AIML model for that functionality that meets the applicability (e.g., or partial applicability) criteria, according to any of the solutions described below.

In the case of model-ID based LCM, the WTRU may make the determination of the associated ID's applicability (e.g., or partial applicability) for each AIML model for that functionality. In some examples, the WTRU may be explicitly configured to make the determination for a certain subset of the AIML models. The WTRU may report the non-applicability, partial applicability or (full) applicability for one or more (e.g., all) of the models (e.g., or the configured subset of models). In some examples, the WTRU may send the list of the applicable models, the list of the non-applicable models, the list of the partial applicable models, etc., or a bitmap indicating which models are applicable or non-applicable. The order in the bitmap may, for example, be based on some model ID soring order agreed upon the WTRU and the network, for example.

An associated ID may be unique for a certain functionality, or it may be shared among multiple functionalities. For cases where an associated ID is applicable for more than one functionality, the WTRU may make the determination of applicability for the associated ID for each of the concerned functionalities according to any of the solutions discussed herein. The WTRU may indicate to the network which of the functionalities the associated ID is applicable to and which it is not (e.g., the list of the applicable functionalities, the list of non-applicable functionalities, the list of partially applicable functionalities, etc., and/or using a bit map structure, similar to the one described above for the model ID based LCM, etc.

In some solutions, the WTRU may be configured to immediately start applying the AIML model/functionality if it determines it to be applicable for the configured/indicated associated ID. In some solutions, the WTRU may indicate the applicability to the network and wait for an indication from the network to further activate the AIML functionality/model.

In some solutions, WTRU may be configured with a time duration. If the WTRU does not receive an indication from the network not to activate the concerned functionality/model (e.g., within the time duration after the reception of the associated ID activation command, within the time duration after the sending of the applicability or partial applicability indication, within the time duration after the reception of a lower layer ACK indicating the reception of the application indication by the network, etc.), it may activate the concerned functionality/model.

The AIML functionalities that are mentioned in the descriptions herein, such as beam management, are illustrative examples, and are by no means limiting to the solutions. For example, the proposed solutions can be used for any AIML functionality, wherein the functionality is to be used in a multi-TRP scenario and/or the functionality is impacted depending on whether the WTRU operates in a single TRP or multi-TRP scenario. The proposed solutions are also equally valid to any other form of functionality that uses prediction that is not based on AIML (e.g., time series forecasting, interpolation methods, etc.).

The solutions described herein may be agnostic to the kind of AIML model/technique used by the WTRU (e.g., the algorithm used, the mechanism such as neural network, what kind of neural network, depth and parameters/weights of the network, etc.), the origins of the model (e.g., WTRU vendor, operator, network vendor, etc.), or how/where the training of the model is done (e.g., the input data used for the training, where the training is performed, if the training is performed offline or online, etc.). However, an AIML model may be trained based on historical observation of one or more UEs' actual measurements in different WTRU and network conditions (e.g., during certain time durations of the day, during certain days of the week, at different locations, different WTRU mobility patterns/speeds, under different network conditions that are visible to the WTRU such as frequency/bandwidth, under different network configurations, which may be visible to the WTRU just as a network configuration index that is provided by the network at the time of training or data collection for the training, etc.).

The concept of sub-associated IDs described herein is not limited to just one level of grouping, where an associated ID contains a group of sub-associated IDs. For example, solutions can be envisioned where a sub-associated ID may have related sub-associated IDs of its own (e.g., several layers of grouping of associated IDs). Additionally, or alternatively, a sub-associated ID may belong to more than one associated ID.

The terms functionality and procedure may be used interchangeably, herein.

Signal prediction based on RS resources configured in two resource sets for Set A and Set B, respectively, is supported. Based on the configuration, prediction of WTRU side/NW side AIML models on signal part can be supported by reporting predicted beam information including the Top K beam indexes, corresponding L1-RSRP values, prediction probability and/or performance monitoring. Interference prediction can be supported in a similar implementation of AIML models.

In some systems involving AIML based beam management, signal prediction may be used. Measured quantities such as L1-RSRP and L1-SINR may be reported.

Herein, how a WTRU may support interference prediction is considered. A WTRU may determine the applicability of an associated ID based on sub-associated IDs. The WTRU may supports AIML based on the determined applicability.

The WTRU may receive configuration information for AIML based interference prediction. The terms “configuration” and “configuration information” may be used interchangeably herein. The configuration information may include one or more of the following.

The configuration information may include one or more RS resources for signal measurement.

The configuration information may include a set of RS resources for interference measurement (e.g., Set B for interference measurement). Each RS resource of the set of RS resources for interference measurement may be associated with M RS resources for interference measurement. The WTRU may apply the same spatial filter for the associated resources (e.g., between a RS resource for signal measurement and M RS resources for interference measurement).

The configuration information may include a set of RS resources for interference prediction (e.g., Set A for interference prediction). Each RS resource for signal measurement may be associated with N RS resources for interference prediction. The WTRU may use (e.g., assume) the same spatial filter for the associated resources (e.g., between a RS resource for signal measurement and N RS resources for interference prediction).

The configuration information may include a reporting configuration including number of beams to be reported (e.g., K for signal and L for channel, respectively).

The WTRU may determine beams and/or qualities of signals and interference to be reported for configured time instances for prediction. In examples, the WTRU may determine measured L1-RSRP values for each resource of Set B (e.g., for signal).

In examples, the WTRU may determine predicted RSSI values for each resource of multiple RS resources for interference prediction. In examples, the WTRU may determine predicted SINR values based on the measured RSRP values and the predicted RSSI values. In examples, the WTRU may determine the Top K resources for signal and/or the Top L resources for each of Top K resources based on AIML model output (e.g., classification model).

Based on the determined qualities, the WTRU may indicate (e.g., in a report) one or more resources in Set B and/or one or more resources of the multiple RS resources for interference prediction (e.g., Set A for interference prediction).

For example, the WTRU may indicate the Top K resources and Top L resources for each of Top K resources.

A benefit is that this approach enables the WTRU to predict interferences and report best/worst interference beams/hypotheses based on measurement of interferences on partial beams/hypotheses.

Examples involving interference prediction for different interference hypotheses are described in greater detail below.

In examples, the WTRU may measure a subset of interference hypotheses (e.g., by measuring a subset of IMRs). Based on the measurement, the WTRU may predict interference in the configured interference hypotheses. Based on the prediction, the WTRU may indicate one or more interference hypotheses (e.g., the best/worst interference hypotheses) for a given beam or one or more best beams. Herein, the “best” interference hypothesis may refer to the hypothesis with best quality (e.g., lowest interference). The “worst” hypothesis may refer to the hypothesis with worst quality (e.g., highest interference).

Configuration is discussed herein. In a solution, a WTRU may receive configuration information for (e.g., AIML based) interference prediction. The configuration information may include one or more of the following.

The configuration information may include one or more RS resources for signal measurement (e.g., in a first RS resource set e.g., Set B). For example, one or more CSI-RS resources (e.g., for BM) and/or SSBs may be configured for signal measurement.

The configuration information may include one or more RS resources for signal prediction (e.g., in a second RS resource set e.g., Set A). For example, one or more CSI-RS resources (e.g., for BM) and/or SSBs may be configured for signal prediction. The number of the one or more RS resources for signal prediction may be larger than the one or more RS resources for signal measurement.

The configuration information may include one or more RS resources for interference measurement (e.g., in a third RS resource set). For example, one or more interference measurement resources (IMRs) (e.g., zero power (ZP) CSI-RS resources for interference measurement and/or NZP CSI-RS resources for interference measurement) may be configured for interference measurement. Each RS resource for signal measurement and/or signal prediction may be associated with M RS resources for interference measurement. For example, a first RS resource for signal measurement/prediction may be associated with first M resources in the third RS resource set, a second RS resource for signal measurement/prediction may be associated with second M resources in the third RS resource set, and so on. For the associated resources, the WTRU may apply same DL Rx spatial filter (e.g., the WTRU may apply a same DL Rx spatial filter, that was used for signal measurement/prediction, for interference measurement). M may be different for each RS resource for signal measurement/

The configuration information may include one or more RS resources for interference prediction. For example, one or more IMRs (e.g., ZP CSI-RS resources for interference prediction and/or NZP CSI-RS resources for interference prediction) may be configured for interference measurement. Each RS resource for signal measurement and/or signal prediction may be associated with N RS resources for interference measurement. For example, a first RS resource for signal measurement/prediction may be associated with the first N resources in the third RS resource set, a second RS resource for signal measurement/prediction may be associated with second N resources in the third RS resource set, and so on. For the associated resources, the WTRU may apply the same DL Rx spatial filter (e.g., the WTRU may apply DL Rx spatial filter that was used for signal measurement/prediction for interference measurement).

The configuration information may include a reporting configuration. For example, the WTRU may be configured with reporting configuration for beam/signal/interference measurement and prediction. For the reporting configuration, the WTRU may be configured with number of beams/resources to be reported. The configuration may be separately configured for signal and interference, respectively. For example, the WTRU may be configured with K beams/resources for signal and/or L beams/resources for interference, respectively.

Measurement and determination of quality is now considered. The WTRU may measure the one or more RS resources for signal measurement and/or the one or more RS resources for interference measurement (e.g., based on the configuration).

The WTRU may determine beams and/or qualities of signal and interference to be reported. The WTRU may determine qualities for the one or more RS resources for signal measurement. The qualities may be one or more of RSRP, SINR, CQI, hypothetical BLER and etc. The WTRU may determine qualities for the one or more RS resources for interference measurement. The qualities may be one or more of RSSI, RSRP, SINR, CQI, hypothetical BLER, etc.

Based on the determined qualities for the one or more RS resources for signal measurement and/or the one or more RS resources for interference measurement, the WTRU may determine qualities of the one or more RS resources for signal prediction and/or the one or more RS resources for interference prediction. In examples, one or more of the following may apply.

In examples, the WTRU may determine qualities (e.g., RSRP, SINR, CQI, hypothetical BLER and etc.) of the one or more RS resources for signal prediction based on the measured qualities of the one or more RS resources for signal measurement (e.g., based on prediction of AIML model).

In examples, the WTRU may determine qualities (e.g., RSSI, RSRP, SINR, CQI, hypothetical BLER etc.) of the one or more RS resources for interference prediction based on the measured qualities of the one or more RS resources for interference measurement (e.g., based on prediction of an AIML model).

In examples, the WTRU may determine qualities (e.g., SINR, RSSI, RSRP, CQI, hypothetical BLER etc.) of one or more of the one or more RS resources for signal prediction, the one or more RS resources for interference prediction, and/or a combination of the resources for signal prediction and interference prediction.

The WTRU may determine one or more RS resources to be reported (e.g., based on measured/determined qualities). In examples, one or more of the following may apply.

In examples, the WTRU may determine K resources from the one or more RS resources for signal measurement (e.g., based on the measured qualities, such as the best/worst qualities of the one or more RS resources for signal measurement).

In examples, the WTRU may determine K resources from the one or more RS resources for signal prediction (e.g., based on the determined qualities such as the best/worst qualities of the one or more RS resources for signal prediction).

In examples, the WTRU may determine L resources from the one or more RS resources for interference measurement/prediction (e.g., based on the measured/determined qualities, such as the best/worst qualities of the one or more RS resources for interference prediction).

In examples, the WTRU may determine L resources from the M/N RS resources for interference measurement/prediction associated with each RS resource for signal measurement/prediction (e.g., based on the measured/determined qualities such as the best/worst qualities). The RS resource for signal measurement/prediction may be one of K resources determined by measured/predicted qualities.

WTRU reporting is considered. The WTRU may report measured/predicted beam related information (e.g., based on one or more of the measured qualities, the determined qualities, the determined K resources for signal measurement/prediction and/or the determined L resources for interference measurement/prediction). In examples, one or more of the following may apply.

In examples, the WTRU may report the determined K resources (e.g., CRIs/SSBRIs) from the one or more RS resources for signal measurement/prediction and/or corresponding measured/determined qualities. For example, the WTRU may indicate the determined K resources and/or corresponding measured/predicted RSRPs.

In examples, the WTRU may report the determined L resources (e.g., Interference Measurement Resource Indexes) from the one or more RS resources for interference measurement/prediction and/or corresponding measured/determined qualities. For example, the WTRU may indicate determined L resources and/or corresponding measured/predicted RSSIs.

In examples, the WTRU may report the determined L resources (e.g., Interference Measurement Resource Indexes) from M/N RS resources for interference measurement/prediction associated with each of K reported resources (e.g., CRIs/SSBRIs) and/or corresponding measured/determined qualities. For example, the WTRU may indicate the determined K resources and/or corresponding measured/predicted RSRPs. Based on the determined K resources, the WTRU may indicate L resources for each of K resources and/or corresponding measured/predicted RSSIs (e.g., for each of L resources).

For the reporting of K/L resources, differential reporting may be used. For example, for the best/worst resource, absolute quality may be reported. For other resources in the K/L resources, differential quality from the best/worst resource may be used.

The WTRU reporting may be based on one or more of periodic, semi-persistent and/or aperiodic CSI reporting. The reporting may be transmitted by UL signal in UL resource. The UL signal may be one or more of uplink channel information (UCI), SRS, DMRS, PRACH, etc. The UL resource may be one or more of PUCCH, PUSCH, MAC CE, RRC, SRS, DMRS, PRACH, etc.

TABLE 1
Different interference hypotheses for measurement and prediction.

| | | Different interference |
|---|---|---|
| Key X/Y | IMR # | hypotheses for a given beam |
| X | IMR #1 | WTRU #1 + WTRU #2 |
| Y | IMR #2 | WTRU #1 |
| Y | IMR #3 | WTRU #2 |
| X | IMR #4 | WTRU #4 + WTRU #5 |
| Y | IMR #5 | WTRU #4 |
| Y | IMR #6 | WTRU #5 |

X: measured IMRs for interference
Y: predicted IMRs based on measured IMRs

Examples involving interference prediction for BM-Case 1 are discussed herein. In some cases, a WTRU may measure RS resources for signal and interference. Based on the measurement, the WTRU may predict (e.g., using an AIML model) signal and interference for configured RS resources for prediction. Based on the prediction, the WTRU may indicate one or more best/worst RS resources for prediction.

A WTRU may receive configuration information for interference prediction. The configuration information may include one or more of the following.

The configuration information may include one or more RS resources for signal prediction (e.g., in a first RS resource set e.g., Set A). For example, one or more CSI-RS resources (e.g., for BM) and/or SSBs may be configured for signal prediction. The number of the one or more RS resources for signal prediction may be larger than the number of one or more RS resources for signal measurement.

The configuration information may include one or more RS resources for signal measurement (e.g., in a second RS resource set e.g., Set B). For example, one or more CSI-RS resources (e.g., for BM) and/or SSBs may be configured for signal measurement.

The configuration information may include one or more RS resources for interference measurement (e.g., in a third RS resource set, Set C). For example, one or more interference measurement resources (IMRs) (e.g., ZP CSI-RS resources for interference measurement and/or NZP CSI-RS resources for interference measurement) may be configured for interference measurement. Each RS resource for interference measurement may be associated with each RS resource for signal measurement.

For example, a first RS resource for signal measurement (e.g., in the second RS resource set) may be associated with a first RS resource for interference measurement (e.g., in the third RS resource set), a second RS resource for signal measurement may be associated with a second RS resource for interference measurement, and so on.

For the associated resources, the WTRU may apply the same DL Rx spatial filter. In examples, the WTRU may apply the same DL Rx spatial filter, that was used for signal measurement/prediction, for interference measurement.

In examples, the number of RS resources in the second RS resource set may be same with the number of RS resources in the third RS resource set.

The configuration information may include a reporting configuration. For example, the WTRU may be configured with reporting configuration for beam/signal/interference measurement and prediction.

For the reporting configuration, the WTRU may be configured with numbers (e.g., one or more) of beams/resources to be reported for signal and/or for interference. The configuration may be separately configured for signal and interference, respectively. For example, the WTRU may be configured with K beams/resources for signal and/or L beams/resources for interference, respectively.

For the reporting configuration, the WTRU may be configured with one or more thresholds. The configuration may be separately configured for signal and interference, respectively. For example, the WTRU may be configured with a threshold for signal (e.g., X dB) and interference (e.g., Y dB), respectively.

Measurement and determination of quality is now considered. The WTRU may measure the one or more RS resources for signal measurement and/or the one or more RS resources for interference measurement (e.g., based on the configuration).

The WTRU may determine beams and/or qualities of signal and interference to be reported.

The WTRU may determine a first type of qualities for the one or more RS resources for signal measurement. The first type of qualities may be one or more of RSRP, SINR, CQI, hypothetical BLER, etc.

The WTRU may determine a second type of qualities for the one or more RS resources for interference measurement. The second type of qualities may be one or more of RSSI, RSRP, SINR, CQI, hypothetical BLER, etc.

Based on the determined qualities for the one or more RS resources for signal measurement and/or the one or more RS resources for interference measurement, the WTRU may determine qualities of the one or more RS resources for signal prediction. In examples, one or more of the following may apply.

In examples, the WTRU may determine the first type of qualities (e.g., RSRP) of the one or more RS resources for signal prediction (e.g., based on the measured qualities of the one or more RS resources for signal measurement and/or based on a prediction of an AIML model).

In examples, the WTRU may determine the second type of qualities (e.g., RSSI) of the one or more RS resources for signal prediction (e.g., based on the measured qualities of the one or more RS resources for interference measurement and/or based on a prediction of an AIML model).

For example, the WTRU may determine a third type of qualities (e.g., SINR) of the one or more RS resources for signal prediction (e.g., based on the first type of qualities and/or the second type of qualities).

In a solution, the WTRU may determine one or more RS resources to be reported (e.g., based on the determined qualities). In examples, one or more of the following may apply.

In examples, the WTRU may determine K resources from the one or more RS resources for signal prediction (e.g., based on the first type/the third type of qualities, such as the best/worst qualities, of the one or more RS resources for signal prediction).

For example, the WTRU may determine L resources from the one or more RS resources for signal prediction (e.g., based on the second type of qualities, such as the best/worst qualities, of the one or more RS resources for signal prediction).

WTRU reporting is now considered. The WTRU may report measured/predicted beam related information. For example, the WTRU reporting may be based on one or more of the measured qualities, the determined qualities, the determined K resources for signal prediction, and/or the determined L resources for interference prediction. In examples, one or more of the following may apply.

In examples, the WTRU may report the determined K resources from the one or more RS resources for signal prediction and/or corresponding determined qualities (e.g., the first type and/or the third type of qualities). For example, the WTRU may indicate the determined K resources and/or corresponding measured/predicted RSRPs.

In examples, the WTRU may report the determined L resources from the one or more RS resources for signal prediction and/or corresponding determined qualities (e.g., the second type and/or the third type of qualities). For example, the WTRU may indicate the determined L resources and/or corresponding measured/predicted RSSIs/SINRs.

In examples, the WTRU may report common resources from the determined K resources (e.g., based on the first/third type of qualities) and the determined L resources (e.g., based on the second/third type of qualities). For example, if an RS resource is determined for the K resources as well as the L resources, the WTRU may report the RS resource.

If number of determined common resources is less than K and/or L, the WTRU may apply one or more of the following.

If number of determined common resources is less than K and/or L, the WTRU may fill the remaining information (e.g., for K/L—the number of determined common resources) with a fixed bit (e.g., 0 or 1).

If number of determined common resources is less than K and/or L, the WTRU may determine additional resources to be reported (e.g., K/L—the number of determined common resources) among the determined K/L resources. The determination may be based on the first/second type of qualities (e.g., best/worst qualities). The WTRU may report the same type of qualities for both common resources and additional resources. For example, the first type/third type of qualities may be reported. The WTRU may report different types of qualities for common resources and additional resources. For example, the second/third type of qualities may be reported for the common resources and the first/second type of qualities may be reported for the additional resources. In such a case, one or more different reporting paradigms may be used. For example, differential reporting for the common resources may be based on a best/worst resource among the common resources and differential qualities from the best/worst resource. For example, differential reporting for the additional resources may be based on a best/worst resource among the additional resources and differential qualities from the best/worst resource.

For the reporting of K/L resources, differential reporting may be used. For example, for the best/worst resource, absolute quality may be reported. For other resources in the K/L resources, differential quality from the best/worst resource may be used.

The WTRU reporting may be based on one or more of periodic, semi-persistent and/or aperiodic CSI reporting. The reporting may be transmitted by UL signal in UL resource. The UL signal may be one or more of uplink channel information (UCI), SRS, DMRS, PRACH, etc. The UL resource may be one or more of PUCCH, PUSCH, MAC CE, RRC, SRS, DMRS, PRACH, etc.

TABLE 2
RS resource configuration for measurements
of signal and interference.

| RS resource index | | | | | | | |
|---|---|---|---|---|---|---|---|
| 1 | 2 | 3 | 4 | 5 | 6 | 7 | 8 |

| | | | | |
|---|---|---|---|---|
| Signal | x | x | x | x |
| Interference | y | y | y | y |

x: measured RS resource for signal
y: measured RS resource for interference

Examples involving interference prediction for BM-Case 2 are considered herein.

A WTRU may measure RS resources for signal and interference. Based on the measurement, the WTRU may predict signal and interference for configured RS resources for prediction. Based on the prediction, the WTRU may indicate one or more best/worst RS resources for prediction.

The WTRU may receive configuration information for interference prediction. The configuration information may include one or more of the following.

The configuration information may include one or more RS resources for signal measurement (e.g., in a first RS resource set). For example, one or more CSI-RS resources (e.g., for BM) and/or SSBs may be configured for signal measurement.

The configuration information may include one or more RS resources for interference measurement (e.g., in a second RS resource set). For example, one or more interference measurement resources (IMRs) (e.g., ZP CSI-RS resources for interference measurement and/or NZP CSI-RS resources for interference measurement) may be configured for interference measurement.

Each RS resource for interference measurement may be associated with each RS resource for signal measurement. For example, a first RS resource for signal measurement (e.g., in the first RS resource set) may be associated with a first RS resource for interference measurement (e.g., in the second RS resource set), a second RS resource for signal measurement may be associated with a second RS resource for interference measurement, and so on.

For the associated resources, the WTRU may apply a same DL Rx spatial filter. For example, the WTRU may apply a same DL Rx spatial filter, that was used for signal measurement/prediction, for interference measurement.

The number of RS resources in the first RS resource set may be same with the number of RS resources in the second RS resource set.

Reporting configuration is now considered. The WTRU may be configured with reporting configuration for beam/signal/interference measurement and prediction.

For the reporting configuration, the WTRU may be configured with one or more time instances for measurement. The one or more time instances for measurement may be configured based on the one or more RS resources for signal/interference measurement.

For the reporting configuration, the WTRU may be configured with one or more time instances for prediction. For example, the WTRU may be configured with one or more offsets from the one or more RS resources for signal/interference measurement. In examples, the WTRU may be configured with one or more offsets from configured CSI reporting instances.

For the reporting configuration, the WTRU may be configured with one or more numbers of beams/resources to be reported. The configuration may be separately configured for signal and interference, respectively. For example, the WTRU may be configured with K beams/resources for signal and/or L beams/resources for interference, respectively.

For the reporting configuration, the WTRU may be configured with one or more numbers of time instances to be reported. The configuration may be separately configured for signal and interference, respectively. For example, the WTRU may be configured with M time instances for signal and/or N time instances for interference, respectively.

For the reporting configuration, the WTRU may be configured with one or more thresholds. The configuration may be separately configured for signal and interference, respectively. For example, the WTRU may be configured with a threshold for signal (e.g., X dB) and interference (e.g., Y dB), respectively.

Measurement and determination of quality is now considered. The WTRU may measure the one or more RS resources for signal measurement and/or the one or more RS resources for interference measurement (e.g., based on the configuration).

The WTRU may determine beams and/or qualities of signal and interference to be reported. The WTRU may determine a first type of qualities for the one or more RS resources for signal measurement. The first type of qualities may be one or more of RSRP, SINR, CQI, hypothetical BLER, etc.

The WTRU may determine a second type of qualities for the one or more RS resources for interference measurement. The second type of qualities may be one or more of RSSI, RSRP, SINR, CQI, hypothetical BLER, etc.

Based on the determined qualities for the one or more RS resources for signal measurement and/or the one or more RS resources for interference measurement, the WTRU may determine qualities of the one or more RS resources for signal prediction. In examples, one or more of the following may apply.

In examples, the WTRU may determine the first type of qualities (e.g., RSRP) of the one or more time instances for prediction (e.g., based on the measured qualities of the one or more RS resources for signal measurement and/or based on prediction of an AIML model).

In examples, the WTRU may determine the second type of qualities (e.g., RSSI) of the one or more time instances for prediction (e.g., based on the measured qualities of the one or more RS resources for interference measurement and/or based on prediction of an AIML model).

In examples, the WTRU may determine a third type of qualities (e.g., SINR) of the one or more time instances for prediction (e.g., based on the first type of qualities and/or the second type of qualities).

The WTRU may determine one or more RS resources to be reported (e.g., based on the determined qualities). In examples, one or more of the following may apply.

In examples, the WTRU may determine K resources from the one or more RS resources for signal prediction (e.g., based on the first type/the third type of qualities, such as the best/worst qualities, of the one or more RS resources for signal prediction).

In examples, the WTRU may determine L resources from the one or more RS resources for signal prediction (e.g., based on the second type of qualities such as the best/worst qualities, of the one or more RS resources for signal prediction).

The WTRU may determine one or more time instances to be reported (e.g., based on the determined qualities). In examples, one or more of the following may apply.

In examples, the WTRU may determine M time instances from the one or more time instances for prediction (e.g., based on the first type/the third type of qualities, such as the best/worst qualities).

In examples, the WTRU may determine N time instances from the one or more time instances for prediction (e.g., based on the second type of qualities, such as the best/worst qualities).

WTRU reporting is now considered. The WTRU may report measured/predicted beam related information for the configured time instances. In examples, one or more of the following may apply.

In examples, the WTRU may report one or more time instances (e.g., the best/worst time instances) for the determined K resources (e.g., for the signal measurement) and/or L resources (e.g., for the interference measurement). In an example, the WTRU may report a set of time instances for both signal measurement and interference measurement. In this case, the set of time instances may be common for both K resources and L resources. In another example, the WTRU may report a first set of time instances for signal measurement (e.g., for K resources) and a second set of time instances for interference measurement (e.g., for L resources).

In examples, the WTRU may report the determined K resources from the one or more RS resources for signal measurement and/or corresponding determined qualities (e.g., the first type and/or the third type of qualities) for each of the configured time instances. For example, the WTRU may indicate the determined K resources and/or corresponding measured/predicted RSRPs for each time instance.

In examples, the WTRU may report the determined L resources from the one or more RS resources for signal measurement and/or corresponding determined qualities (e.g., the second type and/or the third type of qualities) for each of the configured time instances. For example, the WTRU may indicate the determined L resources and/or corresponding measured/predicted RSSIs/SINRs for each time instance.

In examples, the WTRU may report common resources from the determined K resources (e.g., based on the first/third type of qualities) and the determined L resources (e.g., based on the second/third type of qualities) for each of the configured time instances. For example, if an RS resource is determined for the K resources as well as the L resources, the WTRU may report the RS resource.

For the reporting of K/L resources, differential reporting may be used (e.g., for each time instance or for all the configured time instances). For example, for the best/worst resource, absolute quality may be reported. For other resources in the K/L resources, differential quality from the best/worst resource may be used.

The WTRU reporting may be based on one or more of periodic, semi-persistent and/or aperiodic CSI reporting. The reporting may be transmitted by UL signal in UL resource. The UL signal may be one or more of uplink channel information (UCI), SRS, DMRS, PRACH, etc. The UL resource may be one or more of PUCCH, PUSCH, MAC CE, RRC, SRS, DMRS, PRACH, etc.

TABLE 3
Time instance configuration for measurements
of signal and interference.

| Time instance index | | | | | | | |
|---|---|---|---|---|---|---|---|
| 1 | 2 | 3 | 4 | 5 | 6 | 7 | 8 |

| | | | | |
|---|---|---|---|---|
| Signal | x | x | x | x |
| Interference | y | y | y | y |

x: measured time instance for signal
y: measured time instance for interference

Examples involving dynamic switching between signal prediction and interference prediction are discussed herein.

A WTRU may determine a mode of operation (e.g., for WTRU measurement and reporting). The mode of operation may be one of a first mode (e.g., signal prediction) and a second mode (e.g., signal/interference prediction).

In examples, the WTRU's determination of the mode of operation may be based on one or more of the following: an explicit indication, and/or a performance metric.

The WTRU may determine a mode of operation based on an explicit indication. For example, the WTRU may receive an indication of the mode of operation (e.g., signal prediction or signal/interference prediction). The indication may be based on (e.g., sent using) one or more of RRC, MAC CE and/or DCI.

The WTRU may determine a mode of operation based on a performance metric. For example, the WTRU may receive one or more thresholds for determination of the mode of operation. The WTRU may receive a configuration (e.g., configuration information) for evaluating performance metrics. For example, the configuration for evaluating performance metrics may be associated with one or more of RS resource sets, RS resources, Resource configurations, CSI report configs and etc. Based on the configuration for evaluating performance metric. The WTRU may determine qualities of the metrics. The metrics may include one or more of: beam prediction accuracy (e.g., whether predicted beams are included in actual best beams based on measurements), predicted quality (e.g., RSRP, RSSI, SINR, hypothetical BLER, etc.) difference with actual measurement, probability of prediction (e.g., from AIML model), measured quality (e.g., RSRP, RSSI, SINR, LOS probability, etc.), etc.

Based on the determined qualities, the WTRU may determine the mode of operation. In examples, if the determined qualities exceed one or more thresholds, the WTRU may determine the second mode of operation (e.g., signal/interference prediction). Otherwise, the WTRU may determine the first mode of operation (e.g., signal prediction). In examples, if the determined qualities for the first mode of operation exceed the determined qualities of the second mode of operation, the WTRU may determine the first mode of operation. Otherwise, the WTRU may determine the second mode of operation.

The WTRU may support different types of WTRU reporting based on the determined mode of operation.

For example, if the WTRU determines the first mode, the WTRU may determine one or more RS resources based on signal measurement/prediction. The WTRU may indicate the determined one or more RS resources (e.g., based on signal measurement and prediction) and/or corresponding first type of qualities (e.g., RSRPs). If the WTRU determines the second mode, the WTRU may determine one or more RS resources based on signal measurement/prediction and interference measurement/prediction. The WTRU may indicate the determined one or more RS resources (e.g., based on signal measurement/prediction and interference measurement/prediction) and/or corresponding second type of qualities (e.g., RSSIs or SINRs).

An example involving determination of applicability of AIML models based on sub-associated IDs is discussed herein.

A WTRU may determine applicability of an associated ID based on sub-associated IDs. The WTRU may support AIML based on the determined applicability.

A WTRU may receive configuration information for interference prediction. The configuration information may include one or more of the following.

The configuration information may include one or more RS resources for signal measurement.

The configuration may include a set of one or more RS resources for interference measurement (e.g., Set B for interference measurement). Each RS resource for signal measurement may be associated with M RS resources for interference measurement. The WTRU may apply the same spatial filter for the associated resources (e.g., between a RS resource for signal measurement and M RS resources for interference measurement).

The configuration may include a set of one or more RS resources for interference prediction (e.g., Set A for interference prediction). Each RS resource for signal measurement may be associated with N RS resources for interference prediction. The WTRU may use (e.g., assume) the same spatial filter for the associated resources (e.g., between a RS resource for signal measurement and N RS resources for interference prediction).

The configuration may include a reporting configuration including number of beams to be reported (e.g., K for signal and L for channel, respectively).

The WTRU may determine beams and/or qualities of signals and interference to be reported for the configured time instances for prediction. The WTRU may determine measured L1-RSRP values for each resource of Set B (e.g., for signal). The WTRU may determine predicted RSSI values for each resource of multiple RS resources for interference prediction. The WTRU may determine predicted SINR values based on the measured RSRP values and the predicted RSSI values. In examples, the WTRU may determine the Top K resources for signal and the Top L resources for each of Top K resources based on AIML model output (e.g., classification model).

Based on the determined qualities, the WTRU may indicate (e.g., via reporting) one or more resources in Set B and one or more resources of the multiple RS resources for interference prediction (e.g., Set A for interference prediction). For example, the WTRU may indicate a Top K resources and Top L resources for each of Top K resources.

One benefit of this solution is that this solution enables the WTRU to predict interferences and report best/worst interference beams/hypotheses based on measurement of interferences on partial beams/hypotheses.

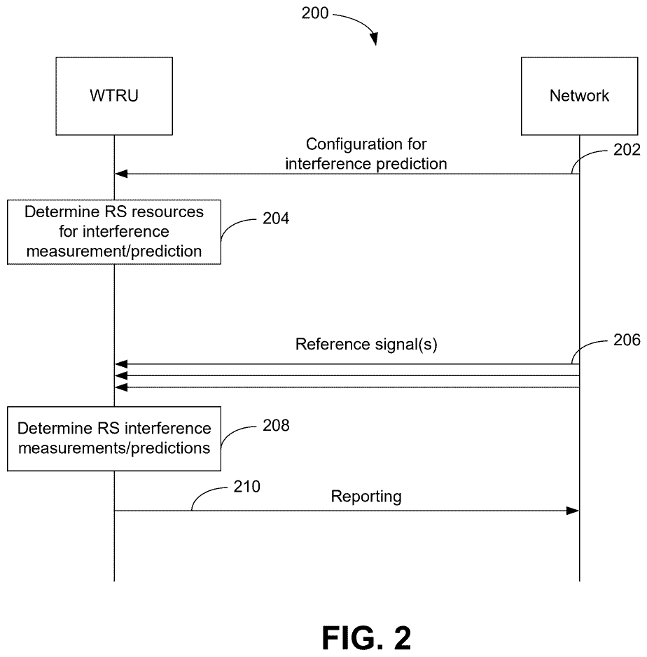

FIG. 2 is a sequence diagram showing an example of a procedure for interference prediction at 200. At 202, the network sends a WTRU a configuration (e.g., configuration information) for interference prediction. As discussed more fully herein, the configuration may indicate, among other things, a set of RS resources (e.g., set A) for prediction and/or a set of resources for measurement (e.g., set B). At 204, the WTRU may determine the RS resources to be used for interference measurement and RS resources for interference prediction. This determination may be based on the configuration sent by the network. At 206, the network may send one or more reference signals to the WTRU. The WTRU may receive and/or measure these RSs at 206. At 208, the WTRU may determine RS interference measurements and may predict (e.g., by using the measurements as input for an AIML model) the interference for one or more (e.g., all) of the RS resources for prediction. At 210, the WTRU may send a report to the network. The report may indicate the RS interference measurements, the RS interference predictions, and/or indicate the associated resources for measurement and/or prediction. The report may, in some cases, include a subset of the total number of configured resources (e.g., the report may indicate the best L resources for interference, for each of the best K resources for signal).

An example involving the prediction for BM-Case 1 is discussed below. The WTRU may measure interference for a subset of beams and predict the best/worst beams by predicting interferences in spatial domain.

A WTRU may receive configuration information indicating one or more of the following: a first RS resource set for Set A; a second RS resource set for Set B; a third IMR resource set for interference measurement (e.g., with ZP CSI-RS resources); and/or a reporting configuration.

The third IMR resource set for interference measurement may include a number of RS resources for interference measurement. This should be same as the number of RS resources in the second resource set for Set B. The third IMR resource set for interference measurement may include a one to one mapping of resources between the second resource set and the third resource set. The WTRU may apply the same spatial Rx filter for each pair of resources (e.g., one resource in the 2nd resource set and one resource in the 3rd resource set).

The reporting configuration may include a number of beams to be reported for signal (e.g., K) and interference (e.g., L), respectively, and/or thresholds to be applied for signal (e.g., X dB) and interference (e.g., Y dB), respectively.

The WTRU may determine beams and/or qualities of signals and interference to be reported.

For example, the WTRU may determine predicted RSRP values for each resource of Set A (e.g., signal prediction). For example, the WTRU may determine predicted RSSI values for each resource of set A (e.g., interference prediction). For example, the WTRU may determine predicted SINR values based on the predicted RSRP values and the predicted RSSI values. For example, the WTRU may determine Top K resources based on AIML model output (e.g., classification model).

Based on the determined qualities, the WTRU may indicate one or more resources in Set A for both signal and interference. In examples, the WTRU may indicate the Top K resources based on the determined predicted SINR values. In examples, the WTRU may indicate one or more top resources within X dB from the best resource based on the determined predicted SINR values. Differential SINR may be used for the reporting, as discussed more fully herein.

In examples, the WTRU may indicate (e.g., via reporting) the Top K resources based on signal prediction. The WTRU may indicate the Top L resources (e.g., with low interference) and/or Worst-L resources (e.g., with high interference) potentially with predicted RSRP values and predicted RSSI values, respectively. In examples, the WTRU may indicate the top resources within X dB from the best signal resource based on the determined predicted RSRP values and/or Top/worst resources within Y dB from the best/worst interference resource based on the determined predicted RSSI values. Differential RSRP and differential RSSI may be used for the reporting.

In examples, the WTRU may indicate common resources between Top resources for signal and Top resources for interference. If number of common resources is less than K, then the WTRU also indicates (K-number of common resources) resources among Top resources which are not included in the common resources.

A benefit is that this solution enables the WTRU to predict interferences and report best/worst interference beams in spatial domain.

An example involving interference prediction for BM-Case 2 is discussed herein. A WTRU may measure interference for a subset of beams and predict the best/worst beams by predicting interferences in temporal domain.

A WTRU may receive configuration information for interference prediction. The configuration information may include one or more of the following: a RS resource set for Set B (e.g., for measurement), a RS resource set for interference measurement, and/or a reporting configuration including time instances for measurement and prediction.

The RS resource set for interference measurement may include a one to one mapping of resources between the resource sets. WTRU may apply the same spatial filter for each pair of resources (e.g., between Set B and interference measurement resources).

The WTRU may determine beams and/or qualities of signals and interference to be reported for the configured time instances for prediction. The WTRU may determine predicted RSRP values for each resource of Set B (e.g., signal prediction) for the configured time instances for prediction. The WTRU may determine predicted RSSI values for each resource of set B (e.g., interference prediction) for the configured time instances for prediction. The WTRU may determine predicted SINR values based on the predicted RSRP values and the predicted RSSI values for the configured time instances for prediction. The WTRU may determine the Top K resources based on the AIML model output (e.g., classification model) for the configured time instances for prediction.

The WTRU may indicate best time instances for each of the Top K resources for signal and/or Top L resources for interference based on the determined beams and the determined qualities.

Based on the determined qualities, the WTRU may indicate one or more resources in Set B for both signal and interference for the configured time instances for prediction. In examples, the WTRU may indicate the Top K resources based on the determined predicted SINR values for each of the configured time instances for prediction. In examples, the WTRU may indicate one or more Top resources within X dB from the best resource based on the determined/predicted SINR values for each of the configured time instances for prediction.

In examples, the WTRU may indicate the Top K resources based on signal prediction and the Top L resources (e.g., with low interference) or Worst-L resources (e.g., with high interference) potentially with predicted RSRP values and predicted RSSI values, respectively, for each of the configured time instances for prediction. In examples, the WTRU may indicate one or more Top resources within X dB from the best signal resource based on the determined predicted RSRP values and Top/worst resources within Y dB from the best/worst interference resource based on the determined predicted RSSI values for each of the configured time instances for prediction.

In examples, the WTRU may indicate common resources between Top resources for signal and Top resources for interference. If number of common resources is less than K, then the WTRU also indicates (K-number of common resources) resources among Top resources which are not included in the common resources, for each of the configured time instances for prediction.

A benefit is that this solution enables the WTRU to predict interferences and report best/worst interference beams in temporal domain.

1. A wireless transmit/receive unit (WTRU) comprising:
a processor, wherein the processor is configured to:
receive configuration information for interference prediction, wherein the configuration information comprises an indication of a first set of reference signal (RS) resources and a second set of RS resources, wherein the first set of RS resources is for interference measurement, and wherein the second set of RS resources is for interference prediction;
determine interference measurements for one or more RSs indicated by the first set of RS resources;
determine an interference prediction for a RS resource in the second set of RS resources based on the interference measurements; and
send an interference prediction report, the interference prediction report indicating the interference prediction.

2. The WTRU of claim 1, wherein the processor is configured to determine the interference prediction using an artificial intelligence or machine learning (AIML) model, wherein the interference measurements are used as input to the AIML model.

3. The WTRU of claim 1, wherein the interference measurements are based on a reference signal received power (RSRP) measurement, a received signal strength indicator (RSSI) measurement, or a signal to noise and interference ratio (SINR) measurement.

4. The WTRU of claim 1, wherein the one or more RSs indicated by the first set of RS resources are channel state information RSs for interference (CSI-IMs) or non-zero power channel state information RSs (NZP CSI-RSs) for interference.

5. The WTRU of claim 1, wherein the processor is configured to determine an interference prediction for each RS resource in the second set of RS resources.

6. The WTRU of claim 5, wherein the interference prediction report includes all of the interference predictions determined for each RS resource in the second set of RS resources.

7. The WTRU of claim 5, wherein the interference prediction report includes a subset of the interference predictions determined for each RS resource in the second set of RS resources.

8. The WTRU of claim 7, wherein the subset of the interference predictions included in the interference prediction report comprises a quantity, L, of interference predictions, wherein the interference predictions comprised in the report are the best L interference predictions or the worst L interference predictions.

9. The WTRU of claim 7, wherein the processor is configured to determine the subset of interference predictions to be included in the interference prediction report based on a comparison of the interference predictions determined for each RS resource in the second set of RS resources with a threshold value for reporting.

10. The WTRU of claim 1, wherein the interference prediction is in decibels (dB).

11. A method for use by a wireless transmit/receive unit (WTRU), the method comprising:
receiving configuration information for interference prediction, wherein the configuration information comprises an indication of a first set of reference signal (RS) resources and a second set of RS resources, wherein the first set of RS resources is for interference measurement, and wherein the second set of RS resources is for interference prediction;
determining interference measurements for one or more RSs indicated by the first set of RS resources;
determining an interference prediction for a RS resource in the second set of RS resources based on the interference measurements; and
sending an interference prediction report, the interference prediction report indicating the interference prediction.

12. The method of claim 11, further comprising determining the interference prediction using an artificial intelligence or machine learning (AIML) model, wherein the interference measurements are used as input to the AIML model.

13. The method of claim 11, wherein the interference measurements are based on a reference signal received power (RSRP) measurement, a received signal strength indicator (RSSI) measurement, or a signal to noise and interference ratio (SINR) measurement.

14. The method of claim 11, wherein the one or more RSs indicated by the first set of RS resources are channel state information RSs for interference (CSI-IMs) or non-zero power channel state information RSs (NZP CSI-RSs) for interference.

15. The method of claim 11, further comprising determining an interference prediction for each RS resource in the second set of RS resources.

16. The method of claim 15, wherein the interference prediction report includes all of the interference predictions determined for each RS resource in the second set of RS resources.

17. The method of claim 15, wherein the interference prediction report includes a subset of the interference predictions determined for each RS resource in the second set of RS resources.

18. The method of claim 17, wherein the subset of the interference predictions included in the interference prediction report comprises a quantity, L, of interference predictions, wherein the L interference predictions comprised in the interference prediction report are the best L interference predictions or the worst L interference predictions.

19. The method of claim 17, further comprising determining the subset of interference predictions to be included in the interference prediction report based on a comparison of the interference predictions determined for each RS resource in the second set of RS resources with a threshold value for reporting.

20. The method of claim 11, wherein the interference prediction is in decibels (dB).
